(19) United States
(12) Patent Application Publication
(10) Pub. No.: US 2022/0383117 A1
(43) Pub. Date: Dec. 1, 2022

(54) BAYESIAN PERSONALIZATION

(71) Applicant: QUALCOMM Incorporated, San Diego, CA (US)

(72) Inventors: Jangho KIM, Siheung (KR); Juntae LEE, Seoul (KR); Simyung CHANG, Suwon (KR)

(21) Appl. No.: 17/824,832

(22) Filed: May 25, 2022

Related U.S. Application Data
(60) Provisional application No. 63/192,993, filed on May 25, 2021.

(51) Int. Cl. G06N 3/08; G06N 5/04

(52) U.S. Cl. CPC G06N 3/08; G06N 5/04

(57) ABSTRACT

A computer-implemented method for generating s personalized neural network model includes accessing a shared or global neural network model. One or more personal inputs of a user are received. A set of features of the one or more inputs is extracted. An approximation of a posterior probability is computed based on the extracted features. A set of personalized weights are generated based on the approximated posterior probability. Processing one or more subsequent inputs via a personal model, including the set of personalized weights, enables generating of an inference.

### CROSS-REFERENCE TO RELATED APPLICATION

The present application claims the benefit of U.S. Provisional Patent Application No. 63/192,993, filed on May 25, 2021, and titled “BAYESIAN PERSONALIZATION,” the disclosure of which is expressly incorporated by reference in its entirety.

### FIELD OF DISCLOSURE

Aspects of the present disclosure generally relate to deep neural networks and model personalization.

### BACKGROUND

Artificial neural networks may comprise interconnected groups of artificial neurons (e.g., neuron models). The artificial neural network may be a computational device or be represented as a method to be performed by a computational device. Convolutional neural networks are a type of feed-forward artificial neural network. Convolutional neural networks may include collections of neurons that each have a receptive field and that collectively tile an input space. Convolutional neural networks (CNNs), such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Artificial neural networks have grown in popularity because of their ability to solve complex problems. As such, it is desirable to incorporate such artificial neural networks on edge devices such as smart phones or other mobile communication devices. Unfortunately, the model size may be prohibitively large with millions of parameters.

### SUMMARY

The present disclosure is set forth in the independent claims, respectively. Some aspects of the disclosure are described in the dependent claims.

In an aspect of the present disclosure, a computer-implemented method is provided. The computer-implemented method includes accessing a shared neural network model. The computer-implemented method also includes receiving one or more inputs. The one or more inputs correspond to a first user. Additionally, the computer-implemented method includes extracting a set of features of the one or more inputs. Further, the computer-implemented method includes computing an approximation of a posterior probability based on the extracted set of features. The computer-implemented method also includes generating a set of personalized weights based on the approximated posterior probability.

In an aspect of the present disclosure, an apparatus is provided. The apparatus includes a memory and one or more processors coupled to the memory. The processor(s) are configured to access a shared neural network model. The processor(s) are also configured to receive one or more inputs. The one or more inputs correspond to a first user. In addition, the processor(s) are configured to extract a set of features of the one or more inputs. Further, the processor(s) are configured to compute an approximation of a posterior probability based on the extracted set of features. The processor(s) are also configured to generate a set of personalized weights based on the approximated posterior probability.

In an aspect of the present disclosure, an apparatus is provided. The apparatus includes means for accessing a shared neural network model. The apparatus also includes means for receiving one or more inputs. The one or more inputs correspond to a first user. Additionally, the apparatus includes means for extracting a set of features of the one or more inputs. Further, the apparatus includes means for computing an approximation of a posterior probability based on the extracted set of features. The apparatus also includes means for generating a set of personalized weights based on the approximated posterior probability.

In an aspect of the present disclosure, a non-transitory computer readable medium is provided. The computer readable medium has encoded thereon program code. The program code is executed by a processor and includes code to access a shared neural network model. The program code also includes code to receive one or more inputs. The one or more inputs correspond to a first user. Additionally, the program code includes code to extract a set of features of the one or more inputs. The program code further includes code to compute an approximation of a posterior probability based on the extracted set of features. The program code also includes code to generate a set of personalized weights based on the approximated posterior probability.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 is a block diagram illustrating an exemplary software architecture that may modularize artificial intelligence (AI) functions, in accordance with aspects of the present disclosure.

FIGS. 5 and 6 are block diagrams illustrating example architectures for generating a personalized neural network model, in accordance with aspects of the present disclosure.

FIG. 7 is a flow diagram illustrating a computer-implemented method for generating a personalized neural network model, in accordance with aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Artificial neural networks have grown in popularity because of their ability to solve complex problems. As such, it is desirable to incorporate artificial neural networks on edge devices, such as smart phones or other mobile communication devices. Unfortunately, edge devices may have computational resource constraints while the model sizes of deep neural networks may be very large, with some models having millions of parameters. Thus, computational cost as well as memory and energy consumption present significant challenges.

With the development of deep learning (DL) technology, the number of DL-based services on edge devices, such as smart phones, Internet of things (IoT) sensors, and other mobile devices, also increased rapidly. In deep learning, conventional approaches have focused on developing a universal model with a sophisticated architecture using a large-scale database to cover an entire target domain. Because of the limitation on computational resources on the edge devices, a global or shared model may be trained on a server and may be broadly distributed to edge devices of many users.

Edge devices may utilize the deep learning models to process (e.g., learn or infer) the personal domain for data generated in a specific environment. Data may be collected by a specific user, or a device may never confront some subdomains. That is, the edge device for each user may be used in many different environments and may capture information (e.g., images, voice data, or other sensor information) that may be unique or personal to the user. In such cases, using a heavy universal model may be inefficient, and performance may be degraded in some personal domains.

Personalization on the edge devices has become an important issue. Personalization involves tailoring a global model to the distribution of personal domains. Conventional approaches to personalization may involve retraining the global model with on-device learning at each personal device. However, such on-device learning is computationally expensive and time consuming on personal devices because of the limited resources.

One challenge for personalization is due to the difficulty in collecting enough personal data. Conventional approaches have attempted to localize multiple models to different personal domains, and then merge the localized model to obtain a universal model. However, the universal model is unable to completely cover a universal domain. In addition, the deployed universal model may encounter various unprecedented personal domains. Although studies in domain adaptation fields have attempted to transfer the knowledge from a source domain to a target domain, these approaches use large amounts of labeled or unlabeled data in the source domain. Therefore, it remains challenging to flexibly personalize a model to a given personal domain using only small-scaled personal data.

To address these and other issues, aspects of the present disclosure are directed to personalization of the shared model on personal devices without retaining the shared model. A meta-framework may generate personal weights for a specific personal identification on an edge device without on-device learning. Accordingly, aspects of the present disclosure may beneficially reduce the cost (e.g., memory and battery consumption) on edge devices related to model training. Moreover, aspects of the present disclosure enable generation of personalized models with high accuracy.

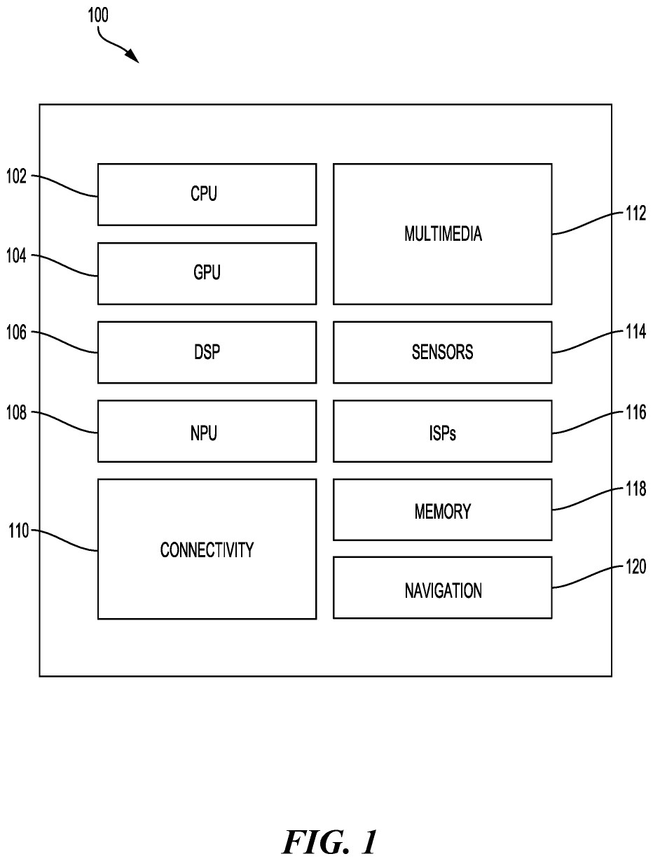

FIG. 1 illustrates an example implementation of a system-on-a-chip (SOC) 100, which may include a central processing unit (CPU) 102 or a multi-core CPU configured for generating a personalized neural network. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system. In one example, sensor processor 114 may be configured to process radio frequency signal or radar signals. For instance, the sensor processor 114 may be configured to receive millimeter wave (mmWave), frequency modulated continuous wave (FMCW), pulse-based radar, or the like.

The SOC 100 may be based on an ARM instruction set. In an aspect of the present disclosure, the instructions loaded into the general-purpose processor 102 may include code to access a shared neural network model. The general-purpose processor 102 may also include code to receive one or more inputs. The inputs correspond to a first user. The general-purpose processor 102 may also include code to extract a set of features of the one or more inputs. The general-purpose processor 102 may further include code to compute an approximation of a posterior probability based on the extracted features. Additionally, the general-purpose processor 102 includes code to generate a set of personalized weights based on the approximated posterior probability.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

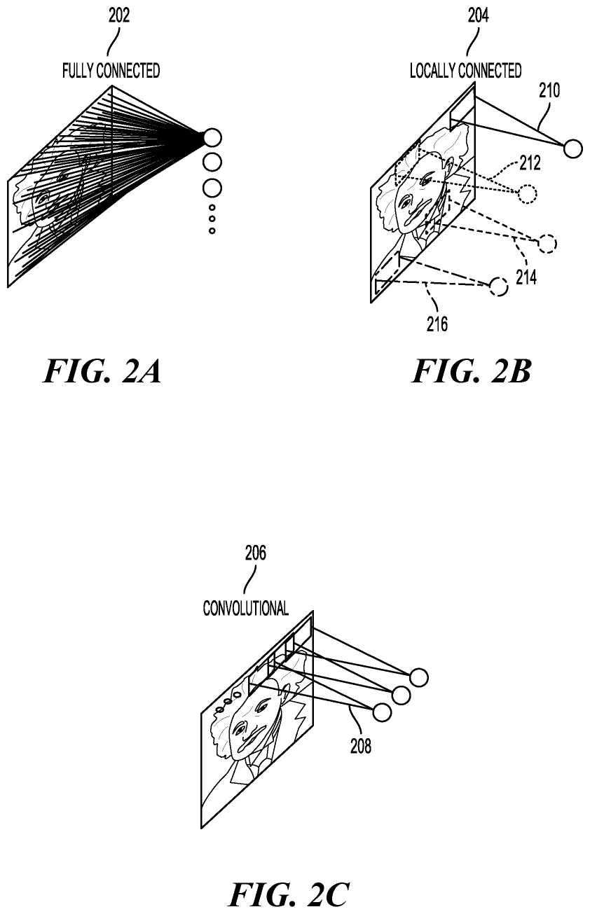

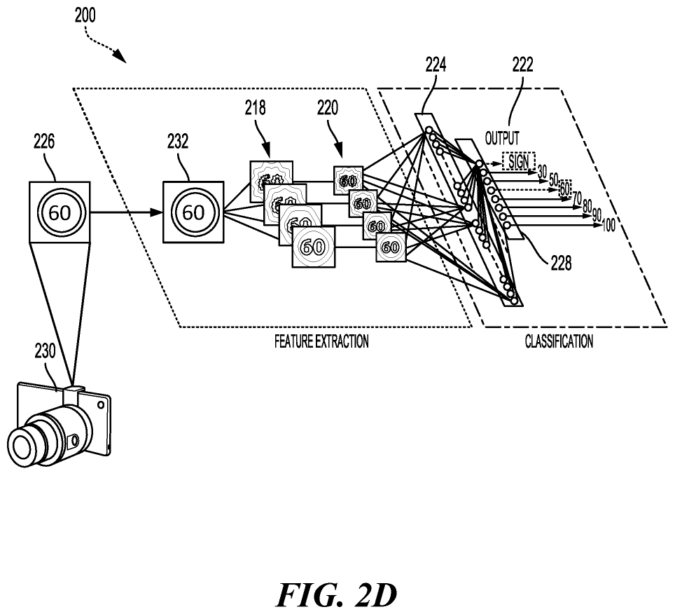

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the output layer, the gradient may correspond directly to the value of a weight connecting an activated neuron in the penultimate layer and a neuron in the output layer. In previous layers, the gradient may depend on the value of the weights and on the computed error gradients of the subsequent layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

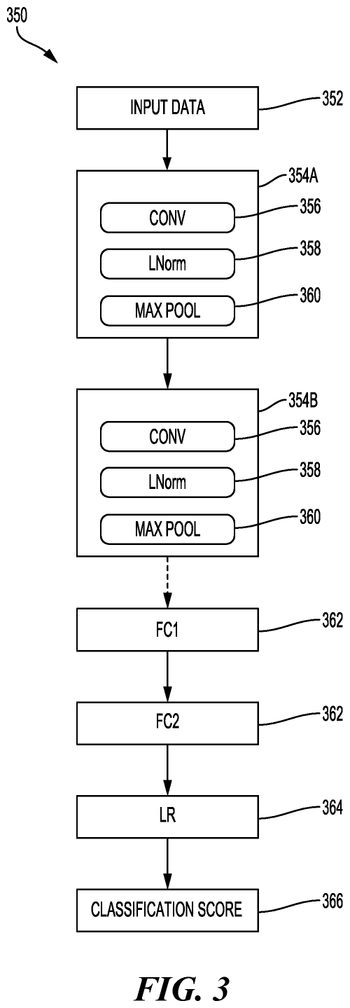

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

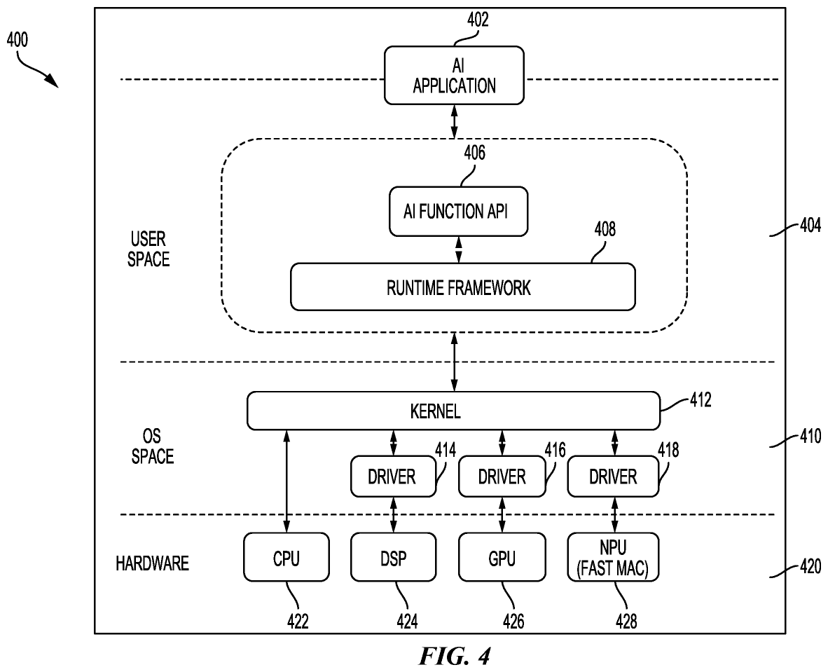

FIG. 4 is a block diagram illustrating an exemplary software architecture 400 that may modularize artificial intelligence (AI) functions. Using the architecture, applications may be designed that may cause various processing blocks of an SOC 420 (for example a CPU 422, a DSP 424, a GPU 426 and/or an NPU 428) to support adaptive rounding as disclosed for post-training quantization for an AI application 402, according to aspects of the present disclosure.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine, for example, to request an inference at a particular time interval or triggered by an event detected by the user interface of the application. When caused to provide an inference response, the run-time engine may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The application 402 (e.g., an AI application) may be configured to call functions defined in a user space 404 that may, for example, provide for the detection and recognition of a scene indicative of the location in which the device currently operates. The application 402 may, for example, configure a microphone and a camera differently depending on whether the recognized scene is an office, a lecture hall, a restaurant, or an outdoor setting such as a lake. The application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

A run-time engine 408, which may be compiled code of a Runtime Framework, may be further accessible to the application 402. The application 402 may cause the run-time engine, for example, to request a scene estimate at a particular time interval or triggered by an event detected by the user interface of the application. When caused to estimate the scene, the run-time engine may in turn send a signal to an operating system 410, such as a Linux Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the differential neural network may be configured to run on a combination of processing blocks, such as a CPU 422 and a GPU 426, or may be run on an NPU 428.

Aspects of the present disclosure are directed to generating a personalized neural network model using few-shot personalization. Few shot personalization is a model personalization based on very few personal examples (e.g., examples that may not have been included in the training examples used in generating the shared model). Given personal data, weights of layers specialized to its personality may be computed on-the-fly (e.g., during runtime) via forwarding only a few personal data examples. A personality may refer to a data distribution of the personal domain on the edge device. A meta unit is trained to capture weight distribution of layers that fit a target person. For instance, the meta unit may be trained to produce an approximated posterior distribution of weights of a layer based on the personality. As the data in a personal domain share the same personality, the target prior distribution may, for example, be set as the averaged distribution of the data in a variational inference of the meta unit.

In a testing phase, the meta unit may estimate a model's weights based on personality by forwarding only a few personal data (e.g., 1-10) examples. Forwarding a small amount of testing data, the meta unit estimates the posterior distribution of weights for the corresponding layer, and the weights of the personalized model are sampled from the estimated posterior distribution. As such, aspects of the present disclosure may perform personalization without training a software platform, which may increase cost in the edge device. Additionally, the meta unit may be detached from the model after sampling the weights of layers, such that in the testing phase, the personalized model may operate without increasing computational cost.

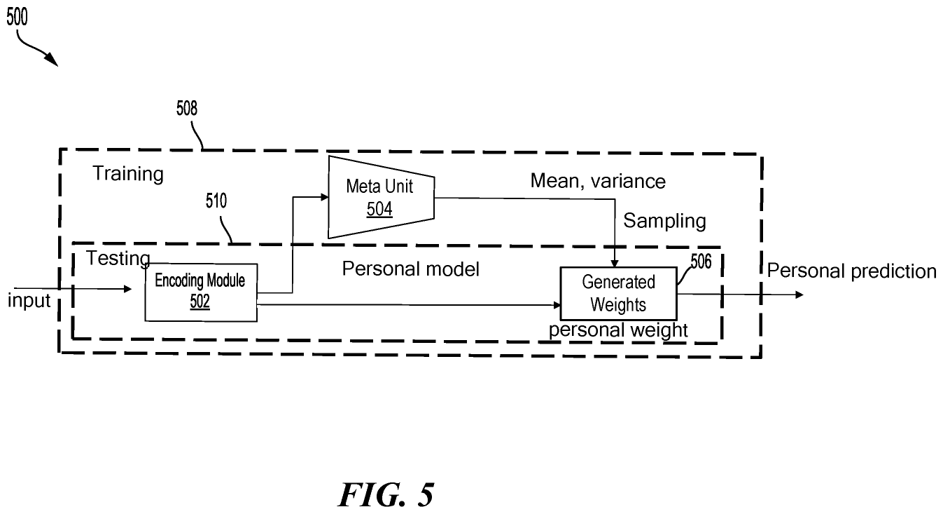

FIG. 5 is a block diagram illustrating an example architecture 500 for generating a personalized model, in accordance with aspects of the present disclosure. Referring to FIG. 5, the example architecture 500 may be implemented at an edge device such as a smartphone or other mobile device, and includes an encoding module 502, a meta unit 504, and a weight generating unit 506. The encoding module 502 (may be referred to as a shared model 502) may be trained on a server (not shown) and distributed to the edge device. As such, the encoding module 502 may be common among a plurality of edge devices and thus may be considered a shared model.

In a training phase 508, a few (e.g., 1-10) examples of personal data (e.g., images) may be supplied along with the shared model information to the meta unit 504. The meta unit 504 may compute a mean and variance, which may in turn be applied for sampling weights of the encoding module 502 to produce personalized weights for each layer of a personal model in the weight generating unit 506.

Thereafter, in a testing phase 510, the meta unit 504 may be detached. Accordingly, the personal model may receive an input and may process the input using the personal weights of the weight generating unit 506 to generate a personal prediction. As such, the architecture 500 may beneficially generate the personal model without retraining and may thereby reduce the use of (and/or reliance on) computational resources (e.g., processors. memory or battery) on resource-limited edge devices. Moreover, the architecture 500 may generate the personal model while maintaining high accuracy.

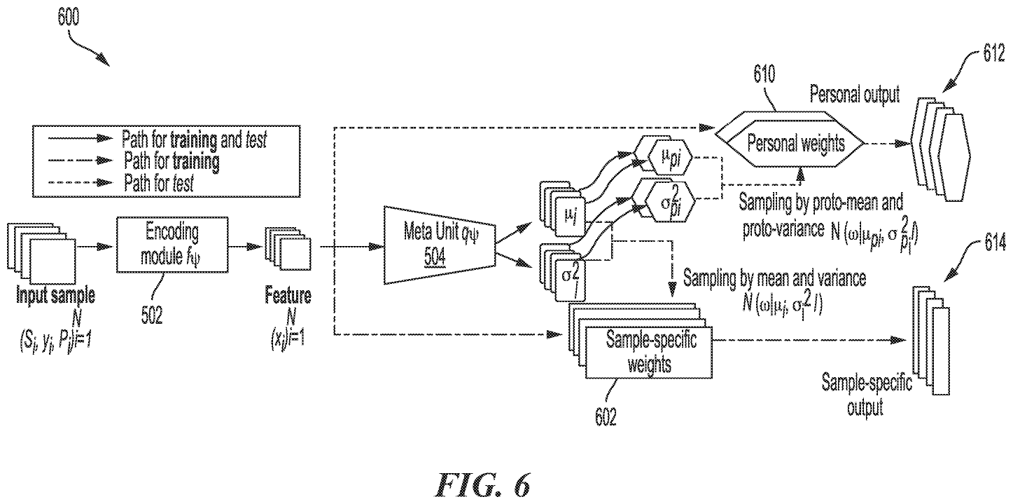

FIG. 6 is a block diagram illustrating an example architecture 600 for generating a personalized model, in accordance with aspects of the present disclosure. Referring to FIG. 6, the example architecture 600 is operated as discussed with reference to FIG. 5.

Given a dataset D={(sᵢ, yᵢpᵢ)ₜ₌₁^{N}}, yᵢ∈{1, . . . , C}, pᵢ∈{1, . . . , [symbol] }, where C is the number of classes, P is the number of identities (e.g., individual clients or tasks), sᵢ represents the i-th sample, yᵢ represents its class label, and pᵢ represents the identity label of i-th sample, one goal is to find the weight distribution representing a personality as sharing the same identity. Finding a true posterior from naive input samples may be difficult. As shown in FIG. 6, the example architecture 600 receives an input sample. The input sample is supplied to the encoding module 502 fψ(⋅) parameterized by ψ, which extracts features Xᵢ from the naive input sample sᵢ. The encoding module 502 may supply the extracted features to the meta unit 504. The meta unit 504 may process the extracted features and approximate the posterior based on the extracted feature (xᵢ=f_{φ}sᵢ)). For simplicity purposes, the i-th feature from the sample having a k-th identity is expressed as (xᵢ^{k}, yᵢ^{k})=(xᵢ, yᵢ(pᵢ=k)). In general, the true posterior p(ω|xᵢ^{k}, yᵢ^{k}) may be difficult to determine. To approximate the true posterior p(ω|xᵢ^{k}, yᵢ^{k}), a variational distribution q_{θ}(ω|xᵢ^{k}) parameterized by θ is used, where ω represents the weights. Then, a Kullback-Leibler (KL) divergence between two distributions may be minimized as follows:

$$\begin{matrix}KL ( {q}_{θ} ( ω \vert {x}_{i}^{k} ) ‖ p ( ω \vert {x}_{i}^{k} , {y}_{i}^{k} ) ) = \int {q}_{θ} ( ω \vert {x}_{i}^{k} ) ln \frac{{q}_{θ} ( ω \vert {x}_{i}^{k} )}{p ( ω \vert {x}_{i}^{k} , {y}_{i}^{k} )} d ω \\ = \int {q}_{θ} ( ω \vert {x}_{i}^{k} ) ln \frac{{q}_{θ} ( ω \vert {x}_{i}^{k} )}{p ( ω \vert {x}_{i}^{k} , {y}_{i}^{k} )} d ω - \\ \int {q}_{θ} ( ω \vert {x}_{i}^{k} ) ln p ( ω \vert {x}_{i}^{k} , {y}_{i}^{k} ) d ω + \\ \int {q}_{θ} ( ω \vert {x}_{i}^{k} ) ln \frac{p ( {x}_{i}^{k} , {y}_{i}^{k} )}{p ( {x}_{i}^{k} )} d ω \\ = KL ( {q}_{θ} ( ω \vert {x}_{i}^{k} ) ‖ p ( ω \vert {x}_{i}^{k} ) ) - \\ {𝔼}_{ω ∼ {q}_{θ} ( ω \vert {x}_{i}^{k} )} [ ln p ( {y}_{i}^{k} \vert {x}_{i}^{k} , ω ) ] + ln p ( {y}_{i}^{k} \vert {x}_{i}^{k} ) .\end{matrix} \qquad ( 1 )$$

Minimization of the KL divergence is equivalent to maximizing the evidence lower bound (ELBO) which may be expressed as:

ELBO= [symbol] _{ω˜q}_{_{θ}}_{(ω|x}_{ᵢ}_{^{k}}₎[ln p(ω|xᵢ^{k},yᵢ^{k})]−KL(q_{θ}(ω|xᵢ^{k})∥p(ω|xᵢ^{k}))≤ln p(yᵢ^{k}|xᵢ^{k}) (2)

where [symbol] represents the expected value.

Maximizing the first expected log likelihood q_{θ}(ω|xᵢ^{k}) and minimizing the second KL term produces a variational distribution that resembles a sample-specific prior p(ω|xᵢ^{k}). This process may be referred to as computing a variational inference (VI). The variational inference approximates the true posterior distribution by minimizing the following objective function (negative ELBO):

[symbol]

_{VI}(θ(xᵢ,yᵢ,k))=− [symbol] _{ω˜qθ(ω|x}_{ᵢ}_{^{k}}₎[ln p(yᵢ^{k}|xᵢ^{k},ω)]+KL(q_{θ}(ω|xᵢ^{k})∥p(ω|xᵢ^{k})). (3)

The first right hand side (RHS) term of equation 3 contains sampling weights co from the distribution q_{θ}(ω|xᵢ^{k}). A pathwise derivative estimator is formed by re-parameterizing a random variable co following q_{θ}(ω|xᵢ^{k}). By introducing a noise variable ∈ following p(∈), the noise variable co may be re-parameterized using a differentiable function g(∈, xᵢ^{k}; θ):

ω=g(∈,xᵢ^{k};θ) with ∈˜p(∈). (4)

Then, equation 3 may be rewritten with respect to P(∈):

$$\begin{matrix}{ℒ}_{VI} ( θ , ( {x}_{i} , {y}_{i} , k ) ) = - \int {q}_{θ} ( ω \vert {x}_{i}^{k} ) ln p ( {y}_{i}^{k} \vert {x}_{i}^{k} , ω ) d ω + \\ KL ( {q}_{θ} ( ω \vert {x}_{i}^{k} ) ‖ p ( ω \vert {x}_{i}^{k} ) ) \\ = - \int p ( ϵ ) ln p ( {y}_{i}^{k} \vert {x}_{i}^{k} , g ( ϵ , {x}_{i}^{k} ; θ ) ) d ϵ + \\ KL ( {q}_{θ} ( ω \vert {x}_{i}^{k} ) ‖ p ( ω \vert {x}_{i}^{k} ) )\end{matrix} \qquad ( 5 )$$

The negative log-likelihood term may be approximated with a Monte Carlo estimator as shown in equation 6. A Monte Carlo estimator approximates the value of an arbitrary integral using random variables.

$$- \int p ( ϵ ) ln p ( {y}_{i}^{k} \vert {x}_{i}^{k} , g ( ϵ , {x}_{i}^{k} ; θ ) ) d ϵ ≃ - \frac{1}{L} {\sum }_{l = 1}^{L} ln p ( {y}_{i}^{k} \vert {x}_{i}^{k} , g ( {ϵ}_{l} , {x}_{i}^{k} ; θ ) ) \qquad ( 6 )$$

where ∈ₗ is independently sampled from p(E). The MC estimator may train θ as follows:

$${ℒ}_{M C} ( θ , ( {x}_{i} , {y}_{i} , k ) ) = - \frac{1}{L} {\sum }_{l = 1}^{L} ln p ( {y}_{i}^{k} \vert {x}_{i}^{k} , g ( {ϵ}_{l} , {x}_{i}^{k} ; θ ) ) + K L ( {q}_{θ} ( ω \vert {x}_{i}^{k} ) ‖ p ( ω \vert {x}_{i}^{k} ) ) . \qquad ( 7 )$$

Thus, given a true posterior q_{θ}(ω|xᵢ^{k}, yᵢ^{k}) and sample-specific prior q_{θ}(ω|xᵢ^{k}) as an uncorrelated multivariate Gaussian, the meta unit 504 may calculate parameters for the variational distribution q_{θ}(ω|xᵢ^{k}) following the isotropic multivariate Gaussian (q_{θ}(ω|xᵢ^{k})= [symbol] (ω|μᵢ, Σᵢ)), where [symbol] is the multivariate normal distribution, Σᵢ=diag(σᵢ²), μ is the mean vector, σ is the variance, and μᵢ and σᵢ² are outputs of the meta unit 504 a scalar variance.

In some aspects, the meta unit 504 may include a fully connected layer (e.g., fully connected layers 362 shown in FIG. 3) with a single hidden layer ((μi, σᵢ²∈ [symbol] ^{Z}, where Z is the dimension of ω), for example.

Sampling according to the mean and variance may then be conducted to generate sample-specific weights 602. The sample-specific weights 602 may, for example, be generated via the weight generating unit 506 shown in FIG. 5. To calculate the KL-divergence term in equation 7, the sample-specific weights 602 may be taken to follow the distribution of the personality (e.g., the identity or task), pᵢ=k, from the sample (xᵢ):

p(ω|xᵢ^{k})≅p(ω|k) (8)

The meta unit 504 may also generate a prototype for making the distribution of the identity (k). The prototype may serve as a representative feature of each support class. Similarly, a prototype distribution for a personality by calculating the sample mean an sample variance within the support set (e.g., minibatch). In each minibatch, Given a set Sₖ of sample indices belonging to the k-th personality (a personality may for example, be a person or a task) and nₖ=|Sₖ|, the meta unit 504 may calculate the means of the meta unit 504 outputs (e.g., means and variance) using all μⱼ and σⱼ², having k-th personality as:

$${\overline{μ}}_{k} = \frac{1}{{n}_{k}} {\sum }_{j ∈ S} {μ}_{j} {\overline{\sum }}_{k} = \frac{1}{{n}_{k}} {\sum }_{j ∈ S} {\sum }_{j} , \qquad ( 9 )$$

where μ̅ₖ and Σ̅ₖ represent the mean and covariance of the distribution of the k-th personality. For simplicity, Σ and Σ̅ may be assume to be diagonal, for example Σ=diag(σ²) and Σ̅=diag (σ̅²), the proto-mean and proto-variance for p(ω|k), respectively. Using a re-parameterization technique, sampling ω from g_{θ}(ω|xᵢ^{k}) may be conducted with following equation:

ω=g(∈₁,xᵢ^{k};θ)=μᵢ+σᵢ²⊙∈₁ with ∈₁˜ [symbol] (0,I), (10)

where ⊙ denotes elementwise multiplication operation. The KL divergence (the second right hand side term of equation 7) can be calculated analytically. The KL divergence may represent a measure of the difference between two probability distributions over the same variable. The KL divergence may be calculated as follows:

$$K L ( {q}_{θ} ( ω \vert {x}_{i}^{k} ) ‖ p ( ω \vert {x}_{i}^{k} ) ) ≃ - \frac{1}{2} {\sum }_{z = 1}^{Z} ( ln {\overline{σ}}_{( k , z )}^{2} - ln {σ}_{( i , z )}^{2} - 1 + \frac{{σ}_{( 1 , z )}^{2}}{{\overline{σ}}_{( k , z )}^{2}} + \frac{{( {μ}_{( i , z )} - {\overline{μ}}_{( k , z )} )}^{2}}{{\overline{σ}}_{( k , z )}^{2}} ) , \qquad ( 11 )$$

where p(ω|xᵢ^{k})≅p(ω|k)˜ [symbol] (ω|μₖ,diag (σ^{k}^{²})) and z∈[Z] is the index of a multivariate Gaussian dimension. The overall loss function of the personal model generated via variational personalization (VP) based on final estimator may therefore be expressed as:

$${ℒ}_{VP} = \frac{1}{N} {\sum }_{i = 1}^{N} ( - \frac{1}{L} {\sum }_{l = 1}^{L} ln p ( {y}_{i}^{{p}_{i}} \vert {x}_{i}^{{p}_{i}} , g ( {ϵ}_{l} , {x}_{i}^{{p}_{i}} ; θ ) ) + KL ( {q}_{θ} ( ω \vert {x}_{I}^{{p}_{i}} ) ‖ p ( ω \vert {x}_{i}^{{p}_{i}} ) ) ) . \qquad ( 12 )$$

The parameters ψ and θ may be trained with the loss function of equation 12.

Thus, in the training phase, the encoding module 502 and the meta unit 504 may be trained using the sample-specific weights 602. After training, an inference 614 may be generated for enrollment samples through the meta unit 504 to generate personal weights (ω) 610 for testing. Additionally, personal weights 610 may also be generated based on re-parameterization with equation 9 using proto-mean and proto-variance output via the meta unit 504. After generating the personal weights 610 for a specific identity, the meta unit 504 may be detached and the encoding module 502 and personal weights 610 may compute a personal output (e.g., an inference) 612 based on the input.

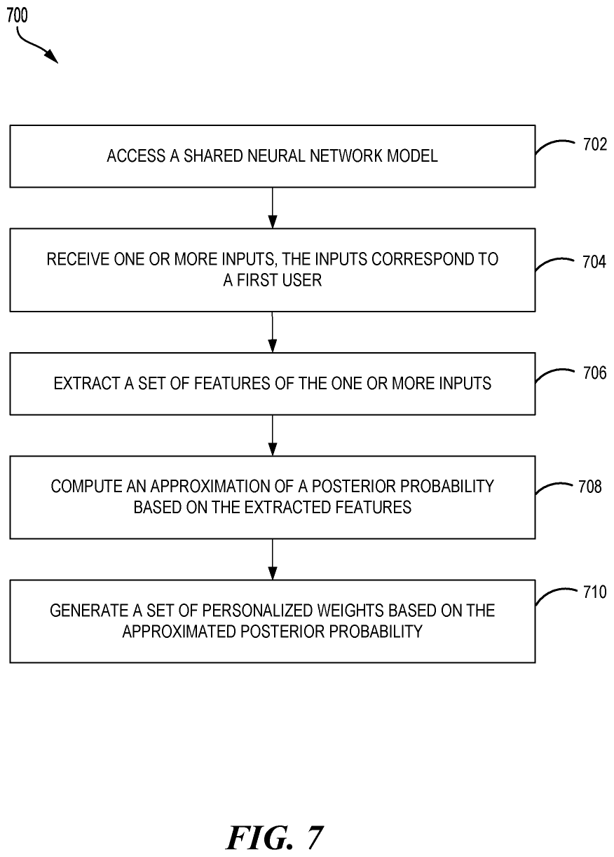

FIG. 7 is a flow diagram illustrating a computer-implemented method 700 for generating a compressed artificial neural network, in accordance with aspects of the present disclosure. At block 702, the computer-implemented method 700 accesses a shared neural network model. As discussed with reference to FIG. 5, an encoding module 502 (may be referred to as a shared model 502) may be trained on a server and distributed to the edge device (e.g., a mobile device). As such, the encoding module 502 may be common among the edge devices and thus may be considered a shared model.

At block 704, the computer-implemented method 700 receives one or more inputs, the inputs corresponding to a first user. As shown in FIG. 6, the example architecture 600 receives an input sample. The input sample corresponds to one of the identities P.

At block 706, the computer-implemented method 700 extracts a set of features of the one or more inputs. The input sample is supplied to the encoding module 502 fψ(⋅) parameterized by ψ, which extracts features Xᵢ from the naive input sample sᵢ. The encoding module 502 supplies the extracted features to meta unit 504.

At block 708, the computer-implemented method 700 computes an approximation of a posterior probability based on the extracted features. As described with reference to the FIG. 6, the meta unit 504 processes the extracted features and approximates the posterior based on the extracted feature (xᵢ=f_{φ}(sᵢ)). For simplicity purposes, the i-th feature from the sample having a k-th identity is expressed as (xᵢ^{k}, yᵢ^{k})=(xᵢ, yᵢ,(pᵢ=k)). To approximate the true posterior (p(ω|xᵢ^{k}, yᵢ^{k}), a variational distribution q_{θ}(ω|xᵢ^{k}) parameterized by θ is used, where ω represents the weights.

At block 710, the computer-implemented method 700 generates a set of personalized weights based on the approximated posterior probability. As described with reference to FIG. 6, sampling according to the mean and variance may then be conducted to generate sample-specific weights 602. The sample-specific weights 602 may, for example, be generated via the weight generating unit 506 shown in FIG. 5. In the training phase, the encoding module 502 and the meta unit 504 may be trained using the sample-specific weights 602. After training, an inference may be generated for enrollment samples through the meta unit 504 to generate personal weights (co) 610 for testing. Additionally, personal weights 610 may also be generated based on re-parameterization with equation 9 using proto-mean and proto-variance output via the meta unit 504. After generating the personal weights 610 for a specific identity, the meta unit 504 may be detached and the encoding module 502 and personal weights 610 may compute a personal output (e.g., an inference) based on the input.

Implementation examples are provided in the following numbered clauses:
1. A computer-implemented method comprising:
accessing a shared neural network model;
receiving one or more inputs, the one or more inputs corresponding to a first user;
extracting a set of features of the one or more inputs;
computing an approximation of a posterior probability based on the extracted set of features; and
generating a set of personalized weights based on the approximated posterior probability.
2. The computer-implemented method of clause 1, further comprising:
receiving one or more subsequent inputs;
processing the one or more subsequent inputs via a personal model including the set of personalized weights; and
generating an inference based on the processing using the personal model.
3. The computer-implemented method of clause 1 or 2, in which the approximated posterior probability is computed based on a mean and variance relative to the one or more inputs.
4. The computer-implemented method of any of clauses 1-3, further comprising:
calculating a mean and a variance based on the extracted set of features; and
sampling weights of the shared model based on the mean and the variance.
5. The computer-implemented method of any of clauses 1-4, in which the mean and the variance are computed during training.
6. The computer-implemented method of any of clauses 1-5, in which the personalized weights are trained based on a model loss function includes a cross-entropy loss and a Kullback-Leibler divergence.
7. The computer-implemented method of any of clauses 1-6, further comprising:
receiving one or more inputs corresponding to a second user; and
generating a second set of personalized weights corresponding to the second user.
8. The computer-implemented method of any of clauses 1-7, further comprising computing in a testing phase, an output based on the personalized weights.
9. An apparatus comprising:
a memory; and
at least one processor coupled to the memory, the at least one processor being configured:
to access a shared neural network model;
to receive one or more inputs, the one or more inputs corresponding to a first user;
to extract a set of features of the one or more inputs;
to compute an approximation of a posterior probability based on the extracted set of features; and
to generate a set of personalized weights based on the approximated posterior probability.
10. The apparatus of clause 9, in which the at least one processor is further configured:
to receive one or more subsequent inputs;
to process the one or more subsequent inputs via a personal model including the set of personalized weights; and
to generate an inference based on the processing using the personal model.
11. The apparatus of clause 9 or 10, in which the at least one processor is further configured compute the approximated posterior probability based on a mean and variance relative to the one or more inputs.
12. The apparatus of any of clauses 9-11, in which the at least one processor is further configured:
to calculate a mean and a variance based on the extracted set of features; and
to sample weights of the shared model based on the mean and the variance.
13. The apparatus of any of clauses 9-12, in which the at least one processor is further configured to compute the mean and the variance during training.
14. The apparatus of any of clauses 9-13, in which the at least one processor is further configured to train the personalized weights based on a model loss function includes a cross-entropy loss and a Kullback-Leibler divergence.
15. The apparatus of any of clauses 9-14, in which the at least one processor is further configured:
to receive one or more inputs corresponding to a second user; and
to generate a second set of personalized weights corresponding to the second user.
16. The apparatus of any of clauses 9-16, in which the at least one processor is further configured to compute, in a testing phase, an output based on the personalized weights.
17. An apparatus comprising:
means for accessing a shared neural network model;
means for receiving one or more inputs, the one or more inputs corresponding to a first user;
means for extracting a set of features of the one or more inputs;
means for computing an approximation of a posterior probability based on the extracted set of features; and
means for generating a set of personalized weights based on the approximated posterior probability.
18. The apparatus of clause 17, further comprising:
means for receiving one or more subsequent inputs;
means for processing the one or more subsequent inputs via a personal model including the set of personalized weights; and
means for generating an inference based on the processing using the personal model.
19. The apparatus of clause 17 or 18, further comprising means for computing the approximated posterior probability based on a mean and variance relative to the one or more inputs.
20. The apparatus of any of clauses 17-19, further comprising:
means for calculating a mean and a variance based on the extracted set of features; and
means for sampling weights of the shared model based on the mean and the variance.
21. The apparatus of any of clauses 17-20, further comprising means for training the personalized weights based on a model loss function includes cross-entropy loss and a Kullback-Leibler divergence.
22. The apparatus of any of clauses 17-21, further comprising:
means for receive one or more inputs corresponding to a second user; and
means for generate a second set of personalized weights corresponding to the second user.
23. The apparatus of any of clauses 17-22, further comprising means for computing, in a testing phase, an output based on the personalized weights.
24. A non-transitory computer readable medium having encoded thereon program code, the program code being executed by a processor and comprising:
program code to access a shared neural network model;
program code to receive one or more inputs, the one or more inputs corresponding to a first user;
program code to extract a set of features of the one or more inputs;
program code to compute an approximation of a posterior probability based on the extracted set of features; and
program code to generate a set of personalized weights based on the approximated posterior probability.
25. The non-transitory computer readable medium of clause 24, further comprising:
program code to receive one or more subsequent inputs;
program code to process the one or more subsequent inputs via a personal model including the set of personalized weights; and
program code to generate an inference based on the processing using the personal model.
26. The non-transitory computer readable medium of clause 24 or 25, further comprising program code to compute the approximated posterior probability based on a mean and variance relative to the one or more inputs.
27. The non-transitory computer readable medium of any of clauses 24-26, further comprising:
program code to calculate a mean and a variance based on the extracted set of features; and
program code to sample weights of the shared model based on the mean and the variance.
28. The non-transitory computer readable medium of any of clauses 24-27, further comprising program code to train the personalized weights based on a model loss function includes a cross-entropy loss and a Kullback-Leibler divergence.
29. The non-transitory computer readable medium of any of clauses 24-28, further comprising:
program code to receive one or more inputs corresponding to a second user; and
program code to generate a second set of personalized weights corresponding to the second user.
30. The non-transitory computer readable medium of any of clauses 24-29, further comprising program code to compute, in a testing phase, an output based on the personalized weights.

In aspects of the present disclosure, a receiving means, extracting means, computing means, and/or generating means may be the CPU 102, program memory associated with the CPU 102, the GPU 104, the dedicated memory block 118, fully connected layers 362, and/or the routing connection processing unit 216 configured to perform the functions recited. In other configurations, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A computer-implemented method comprising:
accessing a shared neural network model;
receiving one or more inputs, the one or more inputs corresponding to a first user;
extracting a set of features of the one or more inputs;
computing an approximation of a posterior probability based on the extracted set of features; and
generating a set of personalized weights based on the approximated posterior probability.

2. The computer-implemented method of claim 1, further comprising:
receiving one or more subsequent inputs;
processing the one or more subsequent inputs via a personal model including the set of personalized weights; and
generating an inference based on the processing using the personal model.

3. The computer-implemented method of claim 1, in which the approximated posterior probability is computed based on a mean and variance relative to the one or more inputs.

4. The computer-implemented method of claim 1, further comprising:
calculating a mean and a variance based on the extracted set of features; and
sampling weights of the shared model based on the mean and the variance.

5. The computer-implemented method of claim 4, in which the mean and the variance are computed during training.

6. The computer-implemented method of claim 1, in which the personalized weights are trained based on a model loss function includes a cross-entropy loss and a Kullback-Leibler divergence.

7. The computer-implemented method of claim 1, further comprising:
receiving one or more inputs corresponding to a second user; and
generating a second set of personalized weights corresponding to the second user.

8. The computer-implemented method of claim 1, further comprising computing in a testing phase, an output based on the personalized weights.

9. An apparatus comprising:
a memory; and
at least one processor coupled to the memory, the at least one processor being configured:
to access a shared neural network model;
to receive one or more inputs, the one or more inputs corresponding to a first user;
to extract a set of features of the one or more inputs;
to compute an approximation of a posterior probability based on the extracted set of features; and
to generate a set of personalized weights based on the approximated posterior probability.

10. The apparatus of claim 9, in which the at least one processor is further configured:
to receive one or more subsequent inputs;
to process the one or more subsequent inputs via a personal model including the set of personalized weights; and
to generate an inference based on the processing using the personal model.

11. The apparatus of claim 9, in which the at least one processor is further configured compute the approximated posterior probability based on a mean and variance relative to the one or more inputs.

12. The apparatus of claim 9, in which the at least one processor is further configured:
to calculate a mean and a variance based on the extracted set of features; and
to sample weights of the shared model based on the mean and the variance.

13. The apparatus of claim 12, in which the at least one processor is further configured to compute the mean and the variance during training.

14. The apparatus of claim 9, in which the at least one processor is further configured to train the personalized weights based on a model loss function includes a cross-entropy loss and a Kullback-Leibler divergence.

15. The apparatus of claim 9, in which the at least one processor is further configured:
to receive one or more inputs corresponding to a second user; and
to generate a second set of personalized weights corresponding to the second user.

16. The apparatus of claim 9, in which the at least one processor is further configured to compute, in a testing phase, an output based on the personalized weights.

17. An apparatus comprising:
means for accessing a shared neural network model;
means for receiving one or more inputs, the one or more inputs corresponding to a first user;
means for extracting a set of features of the one or more inputs;
means for computing an approximation of a posterior probability based on the extracted set of features; and
means for generating a set of personalized weights based on the approximated posterior probability.

18. The apparatus of claim 17, further comprising:
means for receiving one or more subsequent inputs;
means for processing the one or more subsequent inputs via a personal model including the set of personalized weights; and
means for generating an inference based on the processing using the personal model.

19. The apparatus of claim 17, further comprising means for computing the approximated posterior probability based on a mean and variance relative to the one or more inputs.

20. The apparatus of claim 17, further comprising:
means for calculating a mean and a variance based on the extracted set of features; and
means for sampling weights of the shared model based on the mean and the variance.

21. The apparatus of claim 17, further comprising means for training the personalized weights based on a model loss function includes cross-entropy loss and a Kullback-Leibler divergence.

22. The apparatus of claim 17, further comprising:
means for receive one or more inputs corresponding to a second user; and
means for generate a second set of personalized weights corresponding to the second user.

23. The apparatus of claim 17, further comprising means for computing, in a testing phase, an output based on the personalized weights.

24. A non-transitory computer readable medium having encoded thereon program code, the program code being executed by a processor and comprising:
program code to access a shared neural network model;
program code to receive one or more inputs, the one or more inputs corresponding to a first user;
program code to extract a set of features of the one or more inputs;
program code to compute an approximation of a posterior probability based on the extracted set of features; and
program code to generate a set of personalized weights based on the approximated posterior probability.

25. The non-transitory computer readable medium of claim 24, further comprising:
program code to receive one or more subsequent inputs;
program code to process the one or more subsequent inputs via a personal model including the set of personalized weights; and
program code to generate an inference based on the processing using the personal model.

26. The non-transitory computer readable medium of claim 24, further comprising program code to compute the approximated posterior probability based on a mean and variance relative to the one or more inputs.

27. The non-transitory computer readable medium of claim 24, further comprising:
program code to calculate a mean and a variance based on the extracted set of features; and
program code to sample weights of the shared model based on the mean and the variance.

28. The non-transitory computer readable medium of claim 24, further comprising program code to train the personalized weights based on a model loss function includes a cross-entropy loss and a Kullback-Leibler divergence.

29. The non-transitory computer readable medium of claim 24, further comprising:
program code to receive one or more inputs corresponding to a second user; and
program code to generate a second set of personalized weights corresponding to the second user.

30. The non-transitory computer readable medium of claim 24, further comprising program code to compute, in a testing phase, an output based on the personalized weights.
